(19) United States
(12) Patent Application Publication
(10) Pub. No.: US 2007/0002714 A1
(43) Pub. Date: Jan. 4, 2007

(54) Method and apparatus for reproducing data from recording medium

(75) Inventor: Ik Beom Jeon, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/476,643

(22) Filed: Jun. 29, 2006

(30) Foreign Application Priority Data
Jun. 29, 2005 (KR) 10-2005-0056919

(51) Int. Cl. G11B 20/12

(52) U.S. Cl. 369/59.25

(57) ABSTRACT

A method and apparatus for reproducing data from a recording medium is provided. The apparatus detects sync information of a recording unit recorded on a recording medium, and determines whether or not the detected sync information is identical to either normal sync information or pseudo sync information. If the detected sync information is identical to either the normal sync information or the pseudo sync information, the apparatus performs normal decoding of data in the recording unit. This increases the efficiency of data reproduction from the recording medium.

Application No. 10-2005-0056919, filed on Jun. 29, 2005, which is hereby incorporated by reference as if fully set forth herein.

### BACKGROUND OF THE INVENTION

1. Field of the Invention

The present invention relates to a method and apparatus for reproducing data from a recording medium, and more particularly, to a method for reproducing data from a recording medium which efficiently detects sync information of each recording unit in the recording medium and reproduces data therefrom using the detected sync information.

2. Discussion of the Related Art

Optical discs have been widely used as recording media that can record a large amount of data. Of the optical discs, a high-density optical disc (for example, a Blu-ray disc (BD)), which can record/store lengthy high-definition video data and lengthy high-quality audio data, has been developed recently.

The Blu-ray disc represents a next-generation recording medium technology and has been considered an optical recording solution which can store much more data than a conventional DVD. Technical specifications are now being established for the global standardization of the Blu-ray disc, along with standards of other digital devices.

In the meantime, a method and technology for efficiently detecting frame sync information included in each recording frame, the minimum recording unit, in the Blu-ray disc is under discussion. However, an effective and detailed technology has not yet been suggested and there are many challenges in developing a complete optical recording/reproducing device which can efficiently detect the frame sync information.

### SUMMARY OF THE INVENTION

Accordingly, the present invention is directed to a method and apparatus for reproducing data from a recording medium that substantially obviates one or more problems due to limitations and disadvantages of the related art.

An object of the present invention is to provide a method and apparatus for reproducing data from a recording medium, which efficiently detects sync information of each recording unit in the recording medium and reproduces data using the detected sync information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing data from a recording medium comprises detecting sync information of a recording unit recorded on a recording medium; determining whether or not the detected sync information is identical to either normal sync information or pseudo sync information; and decoding the data included in the recording unit if the detected sync information is identical to either the normal sync information or the pseudo sync information.

In another aspect of the present invention, a method for reproducing data from a recording medium comprises setting one or more bit patterns of pseudo sync information; determining that a bit pattern read from a recording medium is sync information if the read bit pattern is identical to any one of the set bit patterns of the pseudo sync information; and reproducing the data included in a recording unit containing the sync information.

In another aspect of the present invention, an apparatus for reproducing data from a recording medium comprises a memory that stores a bit pattern of normal sync information of each recording unit and a bit pattern of pseudo sync information; a sync detector that determines that data read from a recording medium is sync information if a bit pattern identical to the stored bit pattern of the pseudo sync information is detected in the read data; and a controller that performs a control operation for reproducing data included in a recording unit containing the determined sync information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates the structure of a recording unit recorded on a recording medium to which the present invention is applied;

FIG. 2 illustrates the types and bitstreams of recording frame sync information to which the present invention is applied;

FIG. 3 illustrates a table that lists respective sync information types of recording frames to which the present invention is applied;

FIG. 4 illustrates modified bit patterns, regarded as normal bitstreams, of recording frame sync information to which the present invention is applied;

FIG. 5 is a block diagram of an optical recording/reproducing apparatus according to the present invention;

FIG. 6 is a detailed block diagram of a structure, associated with data reproduction, in a signal processor included in the optical recording/reproducing apparatus according to the present invention; and

FIG. 7 is a flow chart of an example of a method for reproducing data from a recording medium according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. Although most terms used in the present invention have been selected from general ones widely used in the art, some terms have been arbitrarily selected by the applicant and their meanings are explained in detail in the following description as needed. Thus, the present invention should be understood with the intended meanings of the terms rather than their simple names or meanings.

The term “recording medium” used in the present invention refers to any recordable medium, for example, an optical disc, a magnetic disc, and a magnetic tape. In the description of the present invention, the recording medium is exemplified by an optical disc for convenience of explanation.

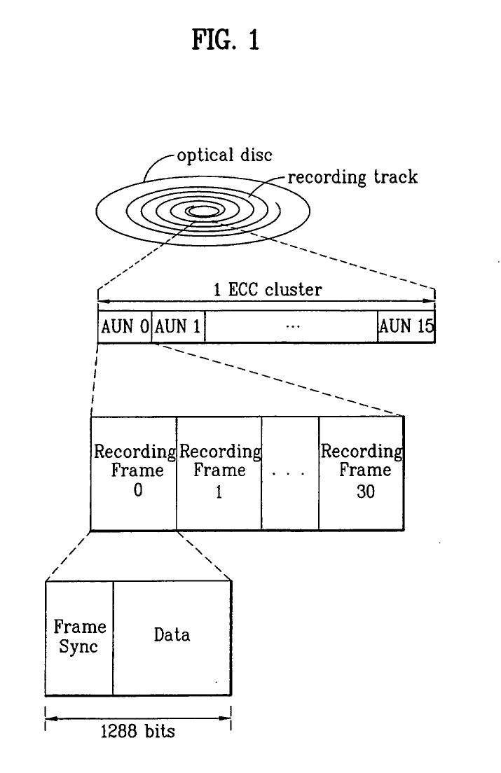

FIG. 1 illustrates the structure of a recording unit recorded on a recording medium to which the present invention is applied. As shown in FIG. 1, an optical disc includes recording regions arranged thereon from the inner section to the outer section. These recording regions are generally referred to as recording tracks. Each recording track includes recording units of the optical disc. For example, the recording units of a Blu-ray disc are referred to as clusters, each of which records data together with an error correction code. This is referred to as an “ECC cluster”.

Each cluster includes a plurality of lower recording units, which are referred to as “address units”. For example, in the case of the Blu-ray disc, each cluster includes 16 address units, which are named “AUN0” to “AUN15”.

Each address unit includes a plurality of lowest recording units, which are referred to as “recording frames”. For example, in the case of the Blu-ray disc, each address unit includes 31 recording frames, each of which includes 1288 bits. Each recording frame includes data and sync information of the recording frame. The sync information of the recording frame not only indicates the beginning of the recording frame but is also used to determine the position of the recording frame in the address unit. Thus, to play an optical disc, it is necessary to correctly detect sync information in each recording frame, which is the minimum recording unit.

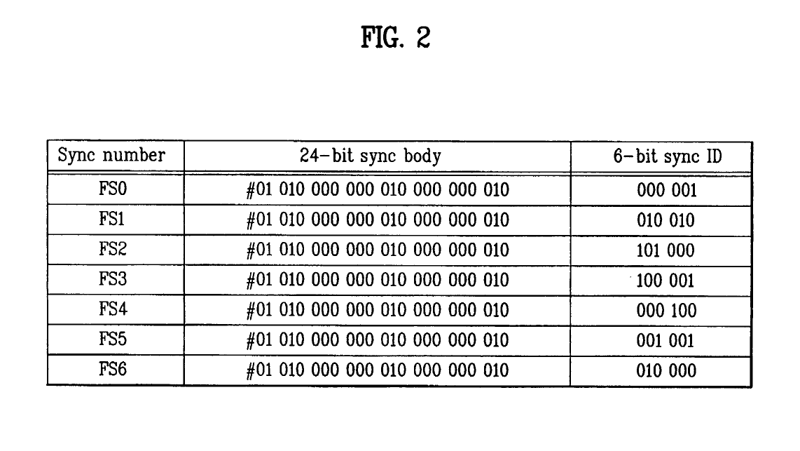

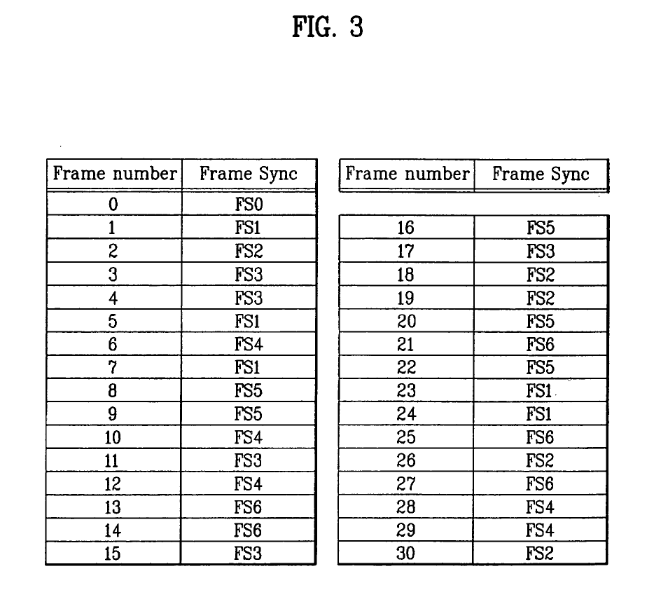

FIGS. 2 and 3 illustrate the type and normal bit pattern of recording frame sync information to which the present invention is applied.

In the example of FIG. 2, the number of types of the recording frame sync information to which the present invention is applied is 7 as denoted by “FS0” to “FS6”.

Each sync information includes 30 channel bits, 24 of the 30 bits being used as a sync body to identify the sync information and the remaining 6 bits being used as a “sync ID” to specify the type of the sync information.

The 24-bit sync body of each sync information has the same value, regardless of the type of the sync information. Thus, if the same 24-bit sync body is detected, recording frame sync information is identified. The 6-bit sync ID of each sync information has a different value, which enables determination of the type of the sync information (for example, one of FS0 to FS6).

The sync body of the sync information may have a bit pattern such as “#01 010 000 000 010 000 000 010”. This indicates that a combination of pits and spaces recorded in the optical disc, which is referred to as a “pit combination” for short, is “2T/9T/9T”. Here, “T” indicates a clock time and “2T/9T/9T” indicates that pits corresponding to “2T” are formed in the optical disc, space sections corresponding to “9T” are then formed in the optical disc, and pits corresponding to “9T” are then formed in the optical disc.

Since the “2T/9T/9T” pit combination is a unique combination that is not used for general data recording, the recording frame sync information can be easily identified by detecting the same pit combination.

For example, the 6-bit sync ID can be defined such that “FS0=000 001”, “FS1=010 001”, “FS2=101 000”, “FS3=100 001”, “FS4=000 100”, “FS5=001 001”, and “FS6=010 000”.

FIG. 3 illustrates a table that lists sync information types of the recording frames. Each of the 31 recording frames in the address unit uses sync information of one of the 7 sync information types illustrated in FIG. 2. The table of FIG. 3 describes a specified rule of Blu-ray discs, which all optical recording/reproducing apparatuses should follow to write or read data to or from Blu-ray discs.

Specifically, the first recording frame (Frame Number 0) has sync information of the type “FS0” and each of the remaining recording frames (Frame Numbers 1 to 30) has sync information of one of the types “FS1” to “FS6”. Sync information of one of the types “FS1” to “FS6” is assigned to each of the remaining recording frames (Frame Numbers 1 to 30) such that the position (i.e., the frame number) of the current recording frame (for example, an nth recording frame) can be determined by reading the sync information of the current recording frame and the sync information of up to four previous recording frames (for example, n-1th to n-4th recording frames).

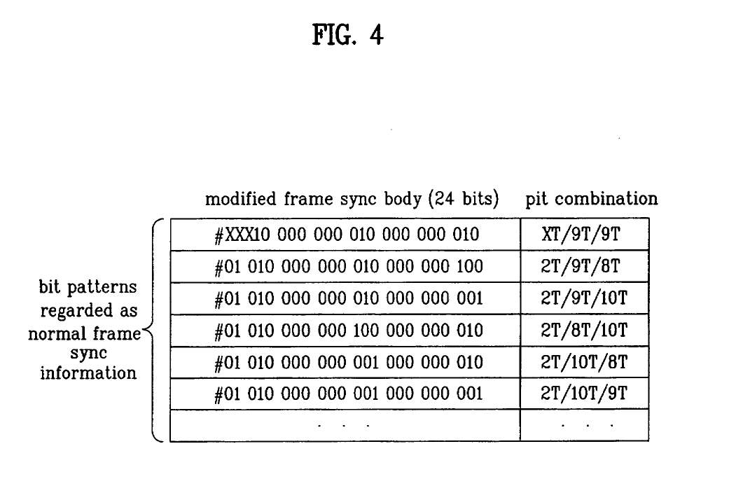

FIG. 4 illustrates modified bit patterns of recording frame sync information to which the present invention is applied.

As described above with reference to FIG. 2, sync information is regarded as normal sync information only when a detected 24-bit sync body of the sync information has a bit pattern “#01 010 000 000 010 000 000 010”. Accordingly, if any one of the 24 channel bits of a sync body of sync information is different from a corresponding bit of the above bit pattern, identification of the sync information fails and all data of the other bits in the same recording frame is also handled as an error. However, taking into consideration the fact that the “2T/9T/9T” pit combination of the sync information provides a very unique bit pattern and does not appear in general data sections, to increase the system efficiency and the data decoding efficiency, the present invention defines pseudo sync information which has a bit pattern within a range similar to the bit pattern of the normal sync information and thus can be regarded as normal sync information even though all bits of the bit pattern are not identical to those of the bit pattern of the normal sync information.

FIG. 4 illustrates a table that lists 24-bit sync bodies of pseudo sync information that is regarded as normal sync information as described above. If the same bit pattern as any one of the 24-bit sync body bit patterns of the pseudo sync information illustrated in FIG. 4 is detected, the detected bit pattern is determined to be a recording frame sync signal.

The system designer can optionally define 24-bit sync bodies of pseudo sync information within a range similar to the 24-bit sync body of the normal sync information of FIG. 2. For example, the system designer can define six 24-bit sync bodies of pseudo sync information as shown in FIG. 4. This is just an example and it is apparent that the system designer can define various other sync bodies of pseudo sync information.

In one example definition of the pseudo sync information, (1) pseudo sync information with a pit combination of “XT/9T/9T” and a corresponding bit pattern of “#XXX10 000 000 010 000 000 010”, (2) pseudo sync information with a pit combination of “2T/9T/8T” and a corresponding bit pattern of “#01 010 000 000 010 000 000 100”, (3) pseudo sync information with a pit combination of “2T/9T/10T” and a corresponding bit pattern of “#01 010 000 000 010 000 000 001”, (4) pseudo sync information with a pit combination of “2T/8T/10T” and a corresponding bit pattern of “#01 010 000 000 100 000 000 010”, (5) pseudo sync information with a pit combination of “2T/10T/8T” and a corresponding bit pattern of “#01 010 000 000 001 000 000 010”, and (6) pseudo sync information with a pit combination of “2T/10T/9T” and a corresponding bit pattern of “#01 010 000 000 010 000 000 001” can be regarded as normal sync information.

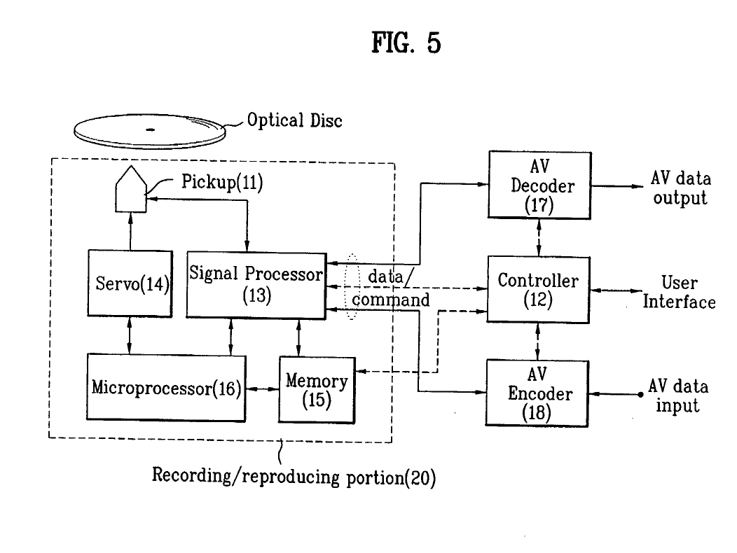

FIGS. 5 to 7 illustrate a method and apparatus for reproducing data from a recording medium according to the present invention.

FIG. 5 is a block diagram of an optical recording/reproducing apparatus to which the present invention is applied. Main elements of the optical recording/reproducing apparatus are a recording/reproducing portion 20 and a controller 12.

The recording/reproducing portion 20 includes a pickup 11, a servo 14, a signal processor 13, a memory 15, and a microprocessor 16. The pickup 11 reads data, management information, and the like recorded on an optical disc. The servo 14 controls the operation of the pickup 11. The signal processor 13 demodulates a reproduced signal received from the pickup 11 into a desired signal value or modulates data into a signal to be recorded on an optical disc and transfers the modulated signal to the pickup 11. The memory 15 temporally stores management information or the like read from the optical disc. The microprocessor 16 controls the operations of the elements of the recording/reproducing portion 20. Herein, the microprocessor 16 is referred to recording/reproducing controller. A product including the recording/reproducing portion 20 alone is referred to as a driver.

The controller 12 controls all the elements of the optical recording/reproducing apparatus. Specifically, the controller 12 receives a user command through an interface with a user and transfers the user command to the microprocessor 16 in the recording/reproducing portion 20 to control it to perform an operation according to the user command. The controller 12 also generates a recording/reproducing command using disc management information received from the recording/reproducing portion 20 and transfers the recording/reproducing command to the recording/reproducing portion 20.

The optical recording/reproducing apparatus further includes an AV decoder 17 and an AV encoder 18. The AV decoder 17 decodes and provides the output data of the recording/reproducing portion 20 to the user under the control of the controller 12. In order to perform an operation for recording an input signal on an optical disc, the AV encoder 18 converts the input signal into a specific format signal (for example, an MPEG2 transport stream) and provides the specific format signal to the signal processor 13 in the recording/reproducing portion 20 under the control of the controller 12.

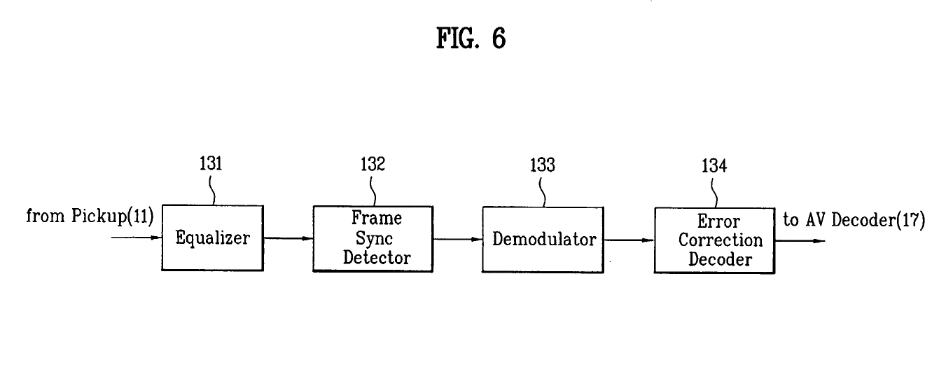

FIG. 6 is a block diagram of part of the signal processor 13, specifically, a structure thereof associated with data reproduction.

The reproduction-related structure of the signal processor 13 includes an equalizer 131, a frame sync detector 132, a demodulator 133, and an error correction decoder 134. When data recorded on a disc is read through the pickup 11 and the read data is input as an RF analog signal to the signal processor 13, the equalizer 11 converts the input RF analog signal into a digital signal having a binary value. The frame sync detector 132 detects the normal sync information illustrated in FIG. 2 or detects the pseudo sync information illustrated in FIG. 4, which is regarded as the normal sync information, in the digital signal. The demodulator 133 demodulates the digital signal and the error correction decoder 134 performs error correction decoding on the demodulated information.

The data reproducing apparatus according to the present invention is characterized by efficiently detecting the recording frame sync information, which is described in detail below.

The memory 15 stores the bit pattern of the normal sync information of each recording frame (see FIG. 2) and the bit patterns of the pseudo sync information (see FIG. 4) that is regarded as normal sync information. Alternatively, the sync information is not necessarily stored in hardware and can be managed as a software program.

The frame sync detector 132 determines that data read from the disc is sync information when detecting a bit pattern in the read data, which is identical to any one of the bit patterns of the pseudo sync information and the bit pattern of the normal sync information stored in the memory 15.

The microprocessor 16 controls the demodulator 133 and the error correction decoder 134 in the signal processor 13 to reproduce data in a recording frame containing the determined sync information.

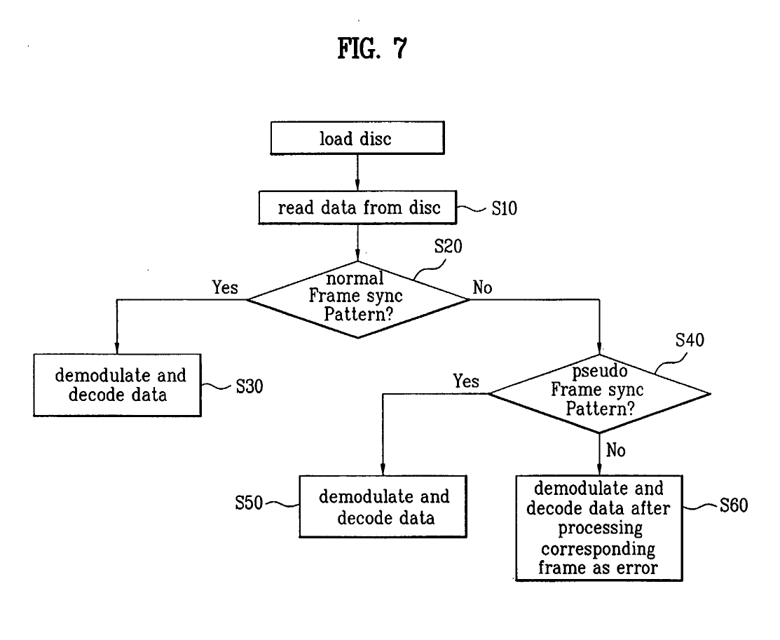

FIG. 7 is a flow chart of an example of a method for reproducing data from a recording medium according to the present invention. Specifically, this flow chart illustrates how recording frame sync information is efficiently detected and data is reproduced based on the detected sync information.

When a disc is loaded, the microprocessor 16 controls the pickup 11 through the servo 14 to read data from the disc (S10). The microprocessor 16 then determines whether or not the same bit pattern as that of the normal recording frame sync information shown in FIG. 2 is present in the read data (S20). If the same bit pattern as that of the normal sync information of FIG. 2 is not detected, the microprocessor 16 determines whether or not the same bit pattern as any one of the bit patterns of the pseudo recording frame sync information defined in FIG. 4 is present in the read data (S40).

If a bit pattern identical to any one of the bit patterns of the pseudo sync information and the bit pattern of the normal sync information is detected at step S20 or S40, the microprocessor 16 determines that the corresponding recording frame is a normal recording frame and then performs demodulation and decoding of the data accordingly (S30 and S50).

If a bit pattern, which is not identical to any one of the bit patterns of the pseudo sync information and the bit pattern of the normal sync information, is detected at step S20 or S40, the microprocessor 16 determines that the detected sync information is erroneous and handles (or processes) all data in the corresponding recording frame as an error and then performs demodulation and decoding of the data accordingly (S60).

At step S60, a large amount of data causes a burst error, thereby imposing a high load on the apparatus when performing error correcting or data decoding, compared to the above step S30 or S50. The method according to the present invention further includes steps S40 and S50, contrary to the conventional method. Accordingly, when the detected recording frame sync information differs from the normal sync information within an allowable range, the detected sync information is regarded as normal sync information, thereby preventing unexpected burst error occurrence.

As is apparent from the above description, the present invention provides a method and apparatus for reproducing data from a recording medium, which increases the efficiency of data reproduction from a recording medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reproducing data from a recording medium, the method comprising:
detecting sync information of a recording unit recorded on a recording medium;
determining whether or not the detected sync information is identical to either normal sync information or pseudo sync information; and
decoding the data included in the recording unit if the detected sync information is identical to either the normal sync information or the pseudo sync information.

2. The method according to claim 1, further comprising determining that the data in the recording unit is an error if the detected sync information is not identical to any one of the normal sync information and the pseudo sync information.

3. The method according to claim 1, wherein the recording unit is a recording frame and the sync information is frame sync information.

4. The method according to claim 1, wherein the normal sync information includes sync body bits used to identify sync information and sync ID bits used to specify a sync information type.

5. The method according to claim 4, wherein the normal sync information has a plurality of types and the sync body bits are the same for each of the sync information types.

6. The method according to claim 1, wherein the pseudo sync information has a plurality of types and it is determined that the detected sync information is normal sync information if the detected sync information is identical to any one of the plurality types of pseudo sync information.

7. The method according to claim 4, wherein the sync body bits of the normal sync information are a bitstream reproduced from a pit combination of “2T/9T/9T” formed on a recording medium.

8. The method according to claim 7, wherein a pit combination of sync body bits of the pseudo sync information is different from the pit combination of the sync body bits of the normal sync information.

9. The method according to claim 8, wherein the pit combination of the sync body bits of the pseudo sync information is one of “XT/9T/9T”, “2T/9T/8T”, “2T/9T/10T”, “2T/8T/10T”, “2T/10T/8T” and “2T/10T/9T”.

10. A method for reproducing data from a recording medium, the method comprising:
setting one or more bit patterns of pseudo sync information;
determining that a bit pattern read from a recording medium is sync information if the read bit pattern is identical to any one of the set bit patterns of the pseudo sync information; and
reproducing the data included in a recording unit containing the sync information.

11. An apparatus for reproducing data from a recording medium, the apparatus comprising:
a memory that stores a bit pattern of normal sync information of each recording unit and a bit pattern of pseudo sync information;
a sync detector that determines that data read from a recording medium is sync information if a bit pattern identical to the stored bit pattern of the pseudo sync information is detected in the read data; and
a controller that performs a control operation for reproducing data included in a recording unit containing the determined sync information.
